(19) United States
(12) Patent Application Publication
(10) Pub. No.: US 2025/0172396 A1
(43) Pub. Date: May 29, 2025

(54) VISION-AIDED INERTIAL NAVIGATION

(71) Applicant: Regents of the University of Minnesota, Minneapolis, MN (US)

(72) Inventors: Stergios I. Roumeliotis, St Paul, MN (US); Anastasios I. Mourikis, Minneapolis, MN (US)

(73) Assignee: Regents of the University of Minnesota, Minneapolis, MN (US)

(21) Appl. No.: 19/030,261

(22) Filed: Jan. 17, 2025

Related U.S. Application Data
(63) Continuation of application No. 18/051,469, filed on Oct. 31, 2022.
Application No. 18/051,469 is a continuation of application No. 17/457,022, filed on Nov. 30, 2021, now Pat. No. 11,486,707.
Application No. 17/457,022 is a continuation of application No. 16/871,560, filed on May 11, 2020, now Pat. No. 11,519,729.
Application No. 16/871,560 is a continuation of application No. 15/706,149, filed on Sep. 15, 2017, now Pat. No. 10,670,404.
Application No. 15/706,149 is a continuation of application No. 12/383,371, filed on Mar. 23, 2009, now Pat. No. 9,766,074.
(60) Provisional application No. 61/040,473, filed on Mar. 28, 2008.

(51) Int. Cl. G01C 21/16; G05D 1/00; H04W 4/02

(52) U.S. Cl. CPC G01C 21/1656; G01C 21/16; G01C 21/165; G05D 1/00; H04W 4/027

(57) ABSTRACT

Localization and navigation systems and techniques are described. An electronic device comprises a processor configured to maintain a state vector storing estimates for a position of the electronic device at poses along a trajectory within an environment along with estimates for positions for one or more features within the environment. The processor computes, from the image data, one or more constraints based on features observed from multiple poses of the electronic device along the trajectory, and computes updated state estimates for the position of the electronic device in accordance with the motion data and the one or more computed constraints without computing updated state estimates for the features for which the one or more constraints were computed.

### CROSS-REFERENCE TO RELATED APPLICATIONS

This application is a continuation of U.S. patent application Ser. No. 18/051,469, filed on Oct. 31, 2022 and entitled “VISION-AIDED INERTIAL NAVIGATION,” which is a continuation of U.S. patent application Ser. No. 17/457,022, filed on Nov. 30, 2021 and entitled “VISION-AIDED INERTIAL NAVIGATION,” which is a continuation of U.S. patent application Ser. No. 16/871,560, filed on May 11, 2020 and entitled “VISION-AIDED INERTIAL NAVIGATION,” which is a continuation of U.S. patent application Ser. No. 15/706,149, filed on Sep. 15, 2017 and entitled “EXTENDED KALMAN FILTER FOR 3D LOCALIZATION AND VISION-AIDED INERTIAL NAVIGATION,” which is a continuation of U.S. patent application Ser. No. 12/383,371, filed on Mar. 23, 2009 and entitled “VISION-AIDED INERTIAL NAVIGATION,” which claims the benefit of Provisional U.S. Patent Application No. 61/040,473, filed Mar. 28, 2008 and entitled “VISION-AIDED INERTIAL NAVIGATION,” the disclosures of which are incorporated herein by reference in their entireties.

### STATEMENT OF GOVERNMENT RIGHTS

This invention was made with Government support under Grant Number MTP-1263201 awarded by the NASA Mars Technology Program, and support under Grant Number EIA-0324864, IIS-0643680 awarded by the National Science Foundation. The Government has certain rights in this invention.

### TECHNICAL FIELD

This document pertains generally to navigation, and more particularly, but not by way of limitation, to vision-aided inertial navigation.

### BACKGROUND

Existing technologies for navigation are not without shortcomings. For example, global positioning system (GPS) based navigation systems require good signal reception from satellites in orbit. With a GPS-based system, navigation in urban areas and indoor navigation is sometimes compromised because of poor signal reception. In addition, GPS-based systems are unable to provide close-quarter navigation for vehicular accident avoidance. Other navigation systems suffer from sensor errors (arising from slippage, for example) and an inability to detect humans or other obstacles.

### OVERVIEW

This document discloses a system for processing visual information from a camera, for example, and inertial sensor data to provide an estimate of pose or other localization information. The camera provides data including images having a number of features visible in the environment and the inertial sensor provides data with respect to detected motion. A processor executes an algorithm to combine the camera data and the inertial sensor data to determine position, orientation, speed, acceleration or other higher order derivative information.

A number of features within the environment are tracked. The tracked features correlate with relative movement as to the frame of reference with respect to the environment. As the number of features increases, the complexity of the data processing also rises. One example of the present subject matter uses an Extended Kalman filter (EKF) having a computational complexity that varies linearly with the number of tracked features.

In one example, a first sensor provides data for tracking the environmental features and a second sensor provides data corresponding to movement of the frame of reference with respect to the environment. A first sensor can include a camera and a second sensor can include an inertial sensor.

Other types of sensors can also be used. Each sensor can be classified as a motion sensor or as a motion inferring sensor. One example of a sensor that directly detects motion is a Doppler radar system and an example of a sensor that detects a parameter from which motion can be inferred is a camera.

In one example, a single sensor provides data corresponding to the tracked features as well as data corresponding to relative movement of the frame of reference within the environment. Data from the single sensor can be multiplexed in time, in space, or in another parameter.

The sensors can be located on (or coupled to), either or both of the frame of reference and the environment. Relative movement as to the frame of reference and the environment can occur by virtue of movement of the frame of reference within a stationary environment or it can occur by virtue of a stationary frame of reference and a traveling environment.

Data provided by the at least one sensor is processed using a processor that implements a filter algorithm. The filter algorithm, in one example, includes an EKF, however, other filters are also contemplated.

In one example, a system includes a feature tracker, a motion sensor and a processor. The feature tracker is configured to provide feature data for a plurality of features relative to a frame of reference in an environment for a period of time. The motion sensor is configured to provide motion data for navigation of the frame of reference in the environment for the period of time. The processor is communicatively coupled to the feature tracker and communicatively coupled to the motion sensor. The processor is configured to generate at least one of navigation information for the frame of reference and the processor is configured to carry out the estimation at a computational complexity linear with the number of tracked features. Linear computational complexity is attained by simultaneously using each feature's measurements to impose constraints between the poses from which the feature was observed. This is implemented by manipulating the residual of the feature measurements to remove the effects of the feature estimate error (either exactly or to a good approximation).

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a composite view of time sampled travel of a frame of reference relative to an environment.

FIG. 2 illustrates a block diagram of a system.

FIGS. 3A-3D illustrates selected images from a dataset.

FIG. 4 illustrates an estimated trajectory overlaid on a map.

FIGS. 5A-5C illustrates position, attitude and velocity for x-axis, y-axis, and z-axis.

### DETAILED DESCRIPTION

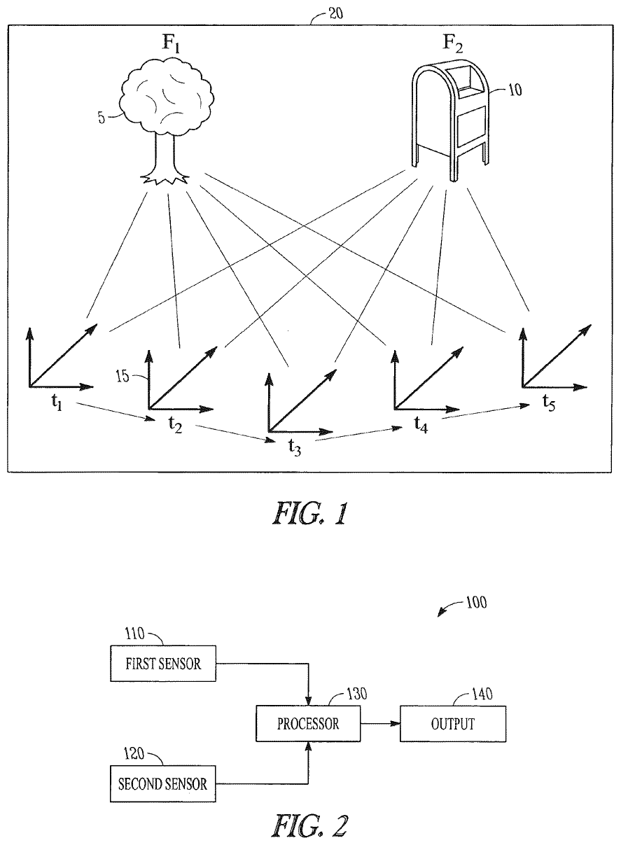

FIG. 1 illustrates a composite view of five time-sampled positions during travel of frame of reference 15 within environment 20. Environment 20 includes two features illustrated here as a tree and a U.S. postal mailbox, denoted as feature 5 and feature 10, respectively. At each of the time sampled points, each of the two features are observed as denoted in the figure. For example, at time t₁, frame of reference 15 observes feature 5 and feature 10 along the line segments illustrated. At a later time t₂, frame of reference 15 again observes feature 5 and feature 10, but with a different perspective. In the figure, the frame of reference travels a curving path in view of the features.

Navigation information as to the relative movement between the frame of reference 15 and the environment 20 can be characterized using sensor data.

Various types of sensors can be identified. A first type of sensor provides direct measurement of quantities related to motion. Data from a sensor of a second type can provide data by which motion can be inferred. Data can also be derived form a statistical model of motion.

A sensor of the first type provides an output that is derived from direct measurement of the motion. For example, a wheel encoder provides data based on rotation of the wheel. Other examples include a speedometer, a Doppler radar, a gyroscope, an accelerometer, an airspeed sensor (such as pitot tube), and a global positioning system (GPS).

A motion inferring sensor provide an output that, after processing, allows an inference of motion. For example, a sequence of camera images can be analyzed to infer relative motion. In addition to a camera (single or multiple), other examples of motion-inferring sensors include a laser scanner (either 2D or 3D), sonar, and radar.

In addition to receiving data from a motion sensor and a motion-inferring sensor, data can also be derived from a statistical probabilistic model of motion. For example, a pattern of vehicle motion through a roadway intersection can provide data for the present subject matter. Additionally, various types of kinematic or dynamic models can be used to describe the motion.

With reference again to FIG. 1, an estimate of the motion of frame of reference 15 at each of the time samples can be generated using an inertial measurement unit (IMU).

In addition, feature 5 and feature 10 can be tracked using a video camera.

FIG. 2 illustrates system 100 according to one example of the present subject matter. System 100 includes first sensor 110 and second sensor 120. In one example, sensor 100 includes a feature tracker and sensor 120 includes a motion sensor, a motion inferring sensor, or a motion tracking model. The figure illustrates two sensors, however, these can be combined and implemented as a single sensor, such as for example, a camera or a radar system, in which the function of sensing motion and tracking features are divided in time, space, or other parameter. In addition, more than two sensors can be provided.

System 100 uses data derived from two sensing modalities which are represented in the figure as first sensor 110 and second sensor 120. The first sensing modality entails detecting motion of the frame of reference with respect to the environment. The first sensing modality expresses a constraint as to consecutive poses and a motion measurement. This motion can be sensed using a direct motion sensor, a motion tracking sensor, a motion inferring sensor or based on feature observations. The second sensing modality includes feature observations and is a function of a particular feature and a particular pose.

System 100 includes processor 130 configured to receive data from the one or more sensors. Processor 130, in one example, includes instructions for implementing an algorithm to process the data and derive navigation information. Processor 130, in one example, implements a filter algorithm, such as a Kalman filter or an extended Kalman filter (EKF).

Data acquired using the feature tracking sensor and a motion sensor (or motion-inferring sensor or a motion tracking model) is processed by an algorithm. The algorithm has complexity linear with the number of tracked features. Linear complexity means that complexity of the calculation doubles with a doubling of the number of features that are in tracked. In order to obtain linear complexity, the algorithm uses feature measurements for imposing constraints between the poses. This is achieved by projecting the residual equation of the filter to remove dependency of the residual on the feature error or higher order terms.

Processor 130 provides an output to output device 140. Output device 140, in various examples, includes a memory or other storage device, a visible display, a printer, an actuator (configured to manipulate a hardware device), and a controller (configured to control another system).

A number of output results are contemplated. For example, the algorithm can be configured to determine a position of a particular feature. The feature is among those tracked by one of the sensors and its position is described as a point in three-dimensional space. The results can include navigation information for the frame of reference. For example, a position, attitude, orientation, velocity, acceleration or other higher order derivative with respect to time can be calculated. In one example, the results include the pose for the frame of reference. The pose includes a description of position and attitude. Orientation refers to a single degree of freedom and is commonly referred to as heading. Attitude, on the other hand, includes the three dimensions of roll, pitch and yaw.

The output can include a position, an orientation, a velocity (linear or rotational), acceleration (linear or rotational) or a higher order derivative of position with respect to time.

The output can be of any dimension, including 1-dimensional, 2-dimensional or 3-dimensional.

The frame of reference can include, for example, an automobile, a vehicle, or a pedestrian. The sensors are in communication with a processor, as shown in FIG. 2, and provide data relative to the frame of reference. For example, a particular sensor can have multiple components with one portion affixed to the frame of reference and another portion affixed to the environment.

In other examples, a portion of a sensor is decoupled from the frame of reference and provides data to a remote processor.

In one example, a feature in space describes a particular point, and thus, its position within an environment can be identified using three degrees of freedom. In contrast to a feature, the frame of reference can be viewed as a rigid body having six degrees of freedom. In particular, the degrees of freedom for a frame of reference can be described as moving up and down, moving left and right, moving forward and backward, tilting up and down (pitch), turning left and right (yaw), and tilting side to side (roll).

Consider next an example of an Extended Kalman Filter (EKF)-based algorithm for real-time vision-aided inertial navigation. This example includes derivation of a measurement model that is able to express the geometric constraints that arise when a static feature is observed from multiple camera poses. This measurement model does not require including the 3D feature position in the state vector of the EKF and is optimal, up to linearization errors. The vision-aided inertial navigation algorithm has computational complexity that is linear in the number of features, and is capable of high-precision pose estimation in large-scale real-world environments. The performance of the algorithm can be demonstrated with experimental results involving a camera/IMU system localizing within an urban area.

### Introduction

Vision-aided inertial navigation has benefited from recent advances in the manufacturing of MEMS-based inertial sensors. Such sensors have enabled small, inexpensive, and very accurate Inertial Measurement Units (IMUs), suitable for pose estimation in small-scale systems such as mobile robots and unmanned aerial vehicles. These systems often operate in urban environments where GPS signals are unreliable (the “urban canyon”), as well as indoors, in space, and in several other environments where global position measurements are unavailable.

Visual sensing provides images with high-dimensional measurements, and having rich information content. A feature extraction method can be used to detect and track hundreds of features in images. However, the high volume of data also poses a significant challenge for estimation algorithm design. When real-time localization performance is required, there is a fundamental trade-off between the computational complexity of an algorithm and the resulting estimation accuracy.

The present algorithm can be configured to optimally utilize the localization information provided by multiple measurements of visual features. When a static feature is viewed from several camera poses, it is possible to define geometric constraints involving all these poses. This document describes a model for expressing these constraints without including the 3D feature position in the filter state vector, resulting in computational complexity only linear in the number of features.

The Simultaneous Localization and Mapping (SLAM) paradigm refers to a family of algorithms for fusing inertial measurements with visual feature observations. In these methods, the current IMU pose, as well as the 3D positions of all visual landmarks are jointly estimated. These approaches share the same basic principles with SLAM-based methods for camera-only localization, with the difference that IMU measurements, instead of a statistical motion model, are used for state propagation. SLAM-based algorithms account for the correlations that exist between the pose of the camera and the 3D positions of the observed features. SLAM-based algorithms, on the other hand, suffer high computational complexity; properly treating these correlations is computationally costly, and thus performing vision-based SLAM in environments with thousands of features remains a challenging problem.

The present subject matter includes an algorithm that expresses constraints between multiple camera poses, and thus attains higher estimation accuracy, in cases where the same feature is visible in more than two images.

The multi-state constraint filter of the present subject matter exploits the benefits of delayed linearization while having complexity only linear in the number of features. By directly expressing the geometric constraints between multiple camera poses it avoids the computational burden and loss of information associated with pairwise displacement estimation. Moreover, in contrast to SLAM-type approaches, it does not require the inclusion of the 3D feature positions in the filter state vector, but still attains optimal pose estimation.

### Estimator Description

A goal of the proposed EKF-based estimator is to track the 3D pose of the IMU-affixed frame {I} with respect to a global frame of reference {G}. In order to simplify the treatment of the effects of the earth's rotation on the IMU measurements (cf. Equations 7 and 8), the global frame is chosen as an Earth-Centered, Earth-Fixed (ECEF) frame. An overview of the algorithm is given in Table 1.

TABLE 1
Multi-State Constraint Filter

| | |
|---|---|
| Propagation | for each IMU measurement received, propagate |
| | the filter state and covariance. |
| Image | Every time a new image is recorded: |
| registration | augment the state and covariance matrix with a |
| | copy of the current camera pose estimate; and |
| | image processing module begins operation. |
| Update | when the feature measurements of a given image |
| | become available, perform an EKF update. |

The IMU measurements are processed immediately as they become available, for propagating the EKF state and covariance. On the other hand, each time an image is recorded, the current camera pose estimate is appended to the state vector. State augmentation is used for processing the feature measurements, since during EKF updates the measurements of each tracked feature are employed for imposing constraints between all camera poses from which the feature was seen. Therefore, at any time instant the EKF state vector comprises (i) the evolving IMU state, X_{IMU}, and (ii) a history of up to Nₘₐₓ past poses of the camera. The various components of the algorithm are described in detail below.

### A. Structure of the EKF State Vector

The evolving IMU state is described by the vector:

$${X}_{IMU} = {[ \begin{matrix}{}_{G}^{I} {\overline{q}}^{T} & {b}_{g}^{T} & {}^{G} {v}_{I}^{T} & {b}_{a}^{T} & {}^{G} {p}_{l}^{T}\end{matrix} ]}^{T} \qquad ( Equation 1 )$$

where _{G}^{I}q̅ is the unit quaternion describing the rotation from frame {G} to frame {I}, ^{G}p_{I}, and ^{G}v_{I} are the IMU position and velocity with respect to {G}, and b_{g} and bₐ are 3×1 vectors that describe the biases affecting the gyroscope and accelerometer measurements, respectively. The IMU biases are modeled as random walk processes, driven by the white Gaussian noise vectors n_{wg} and n_{wa}, respectively. Following Eq. (1), the IMU error-state is defined as:

$${X}_{IMU} = {[ \begin{matrix}{δθ}_{I}^{T} & {\tilde{b}}_{g}^{T} & {}^{G} {\tilde{v}}_{I}^{T} & {\tilde{b}}_{a}^{T} & {}^{G} {\tilde{p}}_{I}^{T}\end{matrix} ]}^{T} \qquad ( Equation 2 )$$

For the position, velocity, and biases, the standard additive error definition is used (i.e., the error in the estimate \hat{x} of a quantity x is defined as x=x−\hat{x}). However, for the quaternion a different error definition is employed. In particular, if \overline{\hat{q}} is the estimated value of the quaternion q̅, then the orientation error is described by the error quaternion δq̅, which is defined by the relation q̅=δq̅⊗\overline{\hat{q}} In this expression, the symbol & denotes quaternion multiplication. The error quaternion is

$$δ \overline{q} ≃ {[ \begin{matrix}\frac{1}{2} {δθ}^{T} & 1\end{matrix} ]}^{T} \qquad ( Equation 3 )$$

Intuitively, the quaternion δq̅ describes the (small) rotation that causes the true and estimated attitude to coincide. Since attitude corresponds to 3 degrees of freedom, using 80 to describe the attitude errors is a minimal representation.

Assuming that N camera poses are included in the EKF state vector at time-step k, this vector has the following form:

$${\hat{X}}_{k} = {[ \begin{matrix}{\hat{X}}_{{IMU}_{k}}^{T} & {}_{G}^{{C}_{1}} {{q}^{\hat{\_}}}^{T} & {}^{G} {\hat{p}}_{{C}_{1}}^{T} … {}_{G}^{{C}_{N}} {{q}^{\hat{\_}}}^{T} & {}^{G} {\hat{p}}_{{C}_{N}}^{T}\end{matrix} ]}^{T} \qquad ( Equation 4 )$$

Where ^{C}^{ᵢ}_{G}\overline{\hat{q}} and ^{G}p̅_{C}_{ᵢ}, i=1 . . . N are the estimates of the camera attitude and position, respectively. The EKF errorstate vector is defined accordingly:

$${\hat{X}}_{k} = {[ {\tilde{X}}_{{IMU}_{k}}^{T} δ {θ}_{{C}_{1}}^{T} {}^{G} {\tilde{p}}_{{C}_{1}}^{T} … {δθ}_{{C}_{N}}^{T} δ {θ}_{{C}_{N}}^{T} ]}^{T} \qquad ( Equation 5 )$$

### B. Propagation

The filter propagation equations are derived by discretization of the continuous-time IMU system model, as described in the following:

### 1) Continuous-Time System Modeling

The time evolution of the IMU state is described by:

$${}_{G}^{I} {q}^{\dot{\_}} ( t ) = \frac{1}{2} {Ω ( ω ( t ) )}_{G}^{I} \overline{q} ( t ) , \dot{{b}_{g}} ( t ) = {n}_{w g} ( t ) \qquad ( Equation 6 )$$

$${}^{G} \dot{v} ( t ) = {}^{G} a ( t ) , \dot{{b}_{a}} ( t ) = {n}_{w a} ( t ) , {}^{G} {p}_{I} ( t ) = {}^{G} {v}_{I} ( t )$$

In these expressions, ^{g}a is the body acceleration in the global frame, ω=[ωₓ ω_{y} ω_{z}]^{T} is the rotational velocity expressed in the IMU frame, and

$$Ω ( ω ) = [ \begin{matrix}- [ \begin{matrix}ω & \times \end{matrix} ] & ω \\ - {ω}^{T} & 0\end{matrix} ] , [ \begin{matrix}ω & \times \end{matrix} ] = [ \begin{matrix}0 & - {ω}_{z} & {ω}_{y} \\ {ω}_{z} & 0 & - {ω}_{x} \\ - {ω}_{y} & {ω}_{x} & 0\end{matrix} ]$$

The gyroscope and accelerometer measurements, ωₘ and aₘ respectively, are given by:

$${ω}_{m} = ω + C ( {}_{G}^{I} \overline{q} ) {ω}_{G} + {b}_{g} + {n}_{g} \qquad ( Equation 7 )$$

$${a}_{m} = C ( {}_{G}^{I} \overline{q} ) {(}^{G} a - {}^{G} g + {2 [ {ω}_{G} \times ]}^{G} {v}_{I} + {[ {ω}_{G} \times ]}^{2} {}^{G} {p}_{I} ) + {b}_{a} + {n}_{a} \qquad ( Equation 8 )$$

where C(·) denotes a rotational matrix, and n_{g} and nₐ are zero-mean, white Gaussian noise processes modeling the measurement noise. Note that the IMU measurements incorporate the effects of the planet's rotation, ∩_{G}. Moreover, the accelerometer measurements include the gravitational acceleration, G_{G}, expressed in the local frame.

Applying the expectation operator in the state propagation equations (Equation 6) yields the equations for propagating the estimates of the evolving IMU state:

$${}_{G}^{I} \overline{q} = \frac{1}{2} Ω ( \hat{ω} ) {}_{G}^{I} {q}^{\hat{\_}} , {{b}^{\dot{ˆ}}}_{g} = {0}_{3 \times 1} , \qquad ( Equation 9 )$$

$${}^{G} {{v}^{\dot{\hat{}}}}_{I} = {C}_{\hat{q}}^{T} \hat{a} - {2 [ {ω}_{G} \times ]}^{G} {\hat{v}}_{I} + {[ {ω}_{G} \times ]}^{2} {}^{G} {\hat{p}}_{I} + {}^{G} g$$

$${{b}^{\dot{\hat{}}}}_{a} = {0}_{3 \times 1} , {}^{G} {{p}^{\dot{\hat{}}}}_{I} = {}^{G} {\hat{v}}_{I}$$

where, for brevity, denote C_{\hat{q}}=C(_{G}^{T}\hat{q̅}), â=aₘ−\hat{b}ₐ and \hat{ω}=ωₘ−\hat{b}_{g}−C_{\hat{q}}ω_{G}. The linearized continuous-time model for the IMU error-state is:

$${{X}^{\dot{\sim}}}_{IMU} = F {\tilde{X}}_{IMU} + G {n}_{IMU} \qquad ( Equation 10 )$$

where n_{IMU}=[n_{g}^{T} n_{wg}^{T} nₐ^{T} n_{wa}^{T}]^{T} is the system noise. The covariance matrix of n_{IMU}, Q_{IMU}, depends on the IMU noise characteristics and is computed off-line during sensor calibration. The matrices F and G that appear in Equation 10 are given by:

$$F = [ \begin{matrix}- [ \begin{matrix}\hat{ω} & \times \end{matrix} ] & - {I}_{3} & {0}_{3 \times 3} & {0}_{3 \times 3} & {0}_{3 \times 3} \\ {0}_{3 \times 3} & {0}_{3 \times 3} & {0}_{3 \times 3} & {0}_{3 \times 3} & {0}_{3 \times 3} \\ - {C}_{\hat{q}}^{T} [ \begin{matrix}\hat{a} & \times \end{matrix} ] & {0}_{3 \times 3} & - 2 [ \begin{matrix}{ω}_{G} & \times \end{matrix} ] & - {C}_{\hat{q}}^{T} & {[ \begin{matrix}{ω}_{G} & \times \end{matrix} ]}^{2} \\ {0}_{3 \times 3} & {0}_{3 \times 3} & {0}_{3 \times 3} & {0}_{3 \times 3} & {0}_{3 \times 3} \\ {0}_{3 \times 3} & {0}_{3 \times 3} & {I}_{3} & {0}_{3 \times 3} & {0}_{3 \times 3}\end{matrix} ]$$

where I₃ is the 3×3 identity matrix, and

$$G = [ \begin{matrix}− {I}_{3} & {0}_{3 \times 3} & {0}_{3 \times 3} & {0}_{3 \times 3} \\ {0}_{3 \times 3} & {I}_{3} & {0}_{3 \times 3} & {0}_{3 \times 3} \\ {0}_{3 \times 3} & {0}_{3 \times 3} & − {C}_{\hat{q}}^{T} & {0}_{3 \times 3} \\ {0}_{3 \times 3} & {0}_{3 \times 3} & {0}_{3 \times 3} & {I}_{3} \\ {0}_{3 \times 3} & {0}_{3 \times 3} & {0}_{3 \times 3} & {0}_{3 \times 3}\end{matrix} ]$$

### 2) Discrete-Time Implementation

The IMU samples the signals ωₘ and aₘ with a period T, and these measurements are used for state propagation in the EKF. Every time a new IMU measurement is received, the IMU state estimate is propagated using 5th order Runge-Kutta numerical integration of Equation 9. The EKF covariance matrix is also propagated. For this purpose, consider the following partitioning for the covariance:

$${P}_{k \vert k} = [ \begin{matrix}{P}_{{II}_{k \vert k}} & {P}_{{IC}_{k \vert k}} \\ {P}_{{IC}_{k \vert k}}^{T} & {P}_{{CC}_{k \vert k}}\end{matrix} ] \qquad ( Equation 11 )$$

where P_{II}_{_{k|k}} is the 15×15 covariance matrix of the evolving IMU state, P_{CC}_{_{k|k}} is the 6N×6N covariance matrix of the camera pose estimates, and P_{IC}_{_{k|k}} is the correlation between the errors in the IMU state and the camera pose estimates. With this notation, the covariance matrix of the propagated state is given by:

$${P}_{k + 1 \vert k} = [ \begin{matrix}{P}_{{II}_{k + 1 \vert k}} & Φ {( {t}_{k} + T , {t}_{k} )}^{T} {P}_{{IC}_{k \vert k}} \\ {P}_{{IC}_{k \vert k}}^{T} {Φ ( {t}_{k} + T , {t}_{k} )}^{T} & {P}_{{CC}_{k \vert k}}\end{matrix} ]$$

where P_{II}_{_{k+1|k}} is computed by numerical integration of the Lyapunov equation:

$${\dot{P}}_{II} = {PF}_{II} + {P}_{II} {F}^{T} + G {Q}_{IMU} {G}^{T} \qquad ( Equation 12 )$$

Numerical integration is carried out for the time interval (tₖ, tₖ+T), with initial condition P_{II}_{_{K|K}}. The state transition matrix Φ(tₖ+T,tₖ) is similarly computed by numerical integration of the differential equation

$$\dot{Φ} ( {t}_{k} + τ , {t}_{k} ) = F Φ ( {t}_{k} + τ , {t}_{k} ) , τ ∈ [ 0 , t ] \qquad ( Equation 13 )$$

with initial condition Φ(tₖ, tₖ)=115.

### C. State Augmentation

Upon recording a new image, the camera pose estimate is computed from the IMU pose estimate as:

$${G}_{C}^{} \hat{\overline{q}} = {I}_{C}^{} \overline{q} {⊗}_{G}^{I} \hat{\overline{q}} , and {}^{G} {\hat{p}}_{C} = {}^{G} {\hat{p}}_{I} + {C}_{\hat{q}}^{T} {}^{I} {\hat{p}}_{C} \qquad ( Equation 14 )$$

where _{I}^{C}q̅ is the quaternion expressing the rotation between the IMU and camera frames, and ^{I}p_{C} is the position of the origin of the camera frame with respect to {I}, both of which are known. This camera pose estimate is appended to the state vector, and the covariance matrix of the EKF is augmented accordingly:

$${P}_{k \vert k} ← [ \begin{matrix}{I}_{6 N + 15} \\ J\end{matrix} ] {{P}_{k \vert k} [ \begin{matrix}{I}_{6 N + 15} \\ J\end{matrix} ]}^{T} \qquad ( Equation 15 )$$

where the Jacobian J is derived from Equation 14 as:

$$J = [ \begin{matrix}C {(}_{I}^{C} \overline{q} ) & {0}_{3 \times 9} & {0}_{3 \times 3} & {0}_{3 \times 6 N} \\ ⌊ {C}_{\hat{q}}^{T} {}^{I} {p}_{C} \times ⌋ & {0}_{3 \times 9} & {I}_{3 \times 9} & {0}_{3 \times 6 N}\end{matrix} ] \qquad ( Equation 16 )$$

### D. Measurement Model

Consider next the measurement model employed for updating the state estimates. Since the EKF is used for state estimation, for constructing a measurement model it suffices to define a residual, r, that depends linearly on the state errors, \tilde{X}, according to the general form:

$$r = H \tilde{X} + noise \qquad ( Equation 17 )$$

In this expression H is the measurement Jacobian matrix, and the noise term must be zero-mean, white, and uncorrelated to the state error, for the EKF framework to be applied.

Viewing a static feature from multiple camera poses results in constraints involving all these poses. Here, the camera observations are grouped per tracked feature, rather than per camera pose where the measurements were recorded. All the measurements of the same 3D point are used to define a constraint equation (cf. Equation 24), relating all the camera poses at which the measurements occurred. This is achieved without including the feature position in the filter state vector.

Consider the case of a single feature, ƒⱼ, that has been observed from a set of Mⱼ camera poses

$$( {}_{G}^{{C}_{i}} \overline{q} , {G}_{{p}_{{C}_{i}}} ) ,$$

i∈Sⱼ. Each of the Mⱼ observations of the feature is described by the model:

$${z}_{i}^{( j )} = \frac{1}{{{C}_{i}}^{} {Z}_{j}} [ \begin{matrix}{{C}_{i}}^{} {X}_{j} \\ {{C}_{i}}^{} {X}_{j}\end{matrix} ] + {n}_{i}^{( j )} , i ∈ {S}_{j} \qquad ( Equation 18 )$$

where nᵢ^{(j)} is the 2×1 image noise vector, with covariance matrix Rᵢ^{(j)}=σᵢₘ²I₂. The feature position expressed in the camera frame,

$${c}_{{i}_{{p}_{{f}_{j}}}} ,$$

is given by:

$${{C}_{i}}^{} {p}_{{f}_{j}} = [ \begin{matrix}{{C}_{i}}^{} {X}_{j} \\ {{C}_{i}}^{} {Y}_{j} \\ {{C}_{i}}^{} {Z}_{j}\end{matrix} ] = C {(}_{G}^{{C}_{i}} \overline{q} ) ( {}^{G} {p}_{{f}_{j}} - {}^{G} {p}_{{C}_{i}} ) \qquad ( Equation 19 )$$

where ^{G}p_{ƒ}_{ⱼ}, is the 3D feature position in the global frame. Since this is unknown, in the first step of the algorithm, employ a least-squares minimization to obtain an estimate,

$${G}_{{\hat{p}}_{{f}_{j}}} ,$$

of the feature position. This is achieved using the measurements zᵢ^{(j), i∈S}ⱼ, and the filter estimates of the camera poses at the corresponding time instants.

Following the estimation of the feature position, compute the measurement residual:

$${r}_{i}^{( j )} = {z}_{i}^{( l )} - {\hat{z}}_{i}^{( j )} \qquad ( Equation 20 )$$

$$where$$

$${\hat{z}}_{i}^{( j )} = \frac{1}{{{C}_{i}}^{} {\hat{Z}}_{j}} [ \begin{matrix}{{C}_{i}}^{} {\hat{X}}_{j} \\ {c}_{i} {\hat{Y}}_{j}\end{matrix} ] [ \begin{matrix}{{C}_{i}}^{} {X}_{j} \\ {{C}_{i}}^{} {Y}_{j} \\ {{C}_{i}}^{} {Z}_{j}\end{matrix} ] = C ( {G}_{C}^{} \hat{\overline{q}} ) ( {}^{G} {\hat{p}}_{{f}_{j}} - {}^{G} {\hat{p}}_{{C}_{i}} )$$

Linearizing about the estimates for the camera pose and for the feature position, the residual of Equation 20 can be approximated as:

$${r}_{i}^{( j )} ≃ {H}_{{X}_{i}}^{( j )} \tilde{X} + {H}_{{f}_{i}}^{( j )} p {}^{G} {\tilde{p}}_{{f}_{j}} + {n}_{i}^{( j )} \qquad ( Equation 21 )$$

In the preceding expression Hₓ_{ᵢ}^{(j) and H}_{ƒ}_{ᵢ}^{(j)} are the Jacobians of the measurement zᵢ^{(j)} with respect to the state and the feature position, respectively, and

$${G}_{{\tilde{p}}_{{f}_{j}}}$$

is the error in the position estimate of ƒⱼ. The exact values of the Jacobians in this expression are generally available. Stacking the residuals of all Mⱼ measurements of this feature yields:

$${r}^{( j )} ≃ {H}_{X}^{( j )} \tilde{X} + {H}_{f}^{( j )} {}^{G} {\tilde{p}}_{{f}_{j}} + {n}^{( j )} \qquad ( Equation 22 )$$

where r^{(j)}, Hₓ^{(j)}, H_{ƒ}^{(j)}, and n^{(j)} are block vectors or matrices with elements rᵢ^{(j)}, Hₓ_{ᵢ}^{(j)}, H_{ƒ}_{ᵢ}^{(j)}, and nᵢ^{(j)}, for i∈Sⱼ. Since the feature observations in different images are independent, the covariance matrix of n^{(j)} is R^{(j)}=σᵢₘ²I_{2M}_{ⱼ}).

Note that since the state estimate, X, is used to compute the feature position estimate, the error ^{G}\tilde{p}_{ƒ}_{ⱼ} in Equation 22 is correlated with the errors \tilde{X}. Thus, the residual r^{(j)} is not in the form of Equation 17, and cannot be directly applied for measurement updates in the EKF. To overcome this, define a residual r_{O}^{(j)}, by projecting r^{(j)} on the left nullspace of the matrix H_{ƒ}^{(j)}. Specifically, let A denote the unitary matrix whose columns form the basis of the left nullspace of H_{ƒ} to obtain:

$${r}_{o}^{( j )} = {A}^{T} ( {z}^{( j )} - {\hat{z}}^{( j )} ) ≃ {A}^{T} {H}_{X}^{( j )} \tilde{X} + {A}^{T} {n}^{( j )} \qquad ( Equation 23 )$$

$$= {H}_{o}^{( j )} {\tilde{X}}^{( j )} + {n}_{o}^{( j )} \qquad ( Equation 24 )$$

Since the 2Mⱼ×3 matrix H_{ƒ}^{(j)} has full column rank, its left nullspace is of dimension 2 Mⱼ−3. Therefore, rₒ^{(j)} is a (2 Mⱼ−3)×1 vector. This residual is independent of the errors in the feature coordinates, and thus EKF updates can be performed based on it. Equation 24 defines a linearized constraint between all the camera poses from which the feature zᵢ^{(j)} was observed. This expresses all the available information that the measurements zᵢ^{(j)} provide for the Mⱼ states, and thus the resulting EKF update is optimal, except for the inaccuracies caused by linearization.

In order to compute the residual rₒ^{(j)} and the measurement matrix Hₒ^{(j)}, the unitary matrix A does not need to be explicitly evaluated. Instead, the projection of the vector r and the matrix Hₓ^{(j)} on the nullspace of H_{ƒ}^{(j)} can be computed very efficiently using Givens rotations, in O(Mⱼ²) operations. Additionally, since the matrix A is unitary, the covariance matrix of the noise vector nₒ^{(j)} is given by:

$$E \{ {n}_{o}^{( j )} {n}_{o}^{( j ) T} \} = {σ}_{im}^{2} {A}^{T} A = {σ}_{im}^{2} {I}_{2 {M}_{j} - 3}$$

The residual defined in Equation 23 is not the only possible expression of the geometric constraints that are induced by observing a static feature in Mⱼ images. An alternative approach is, for example, to employ the epipolar constraints that are defined for each of the Mⱼ(Mⱼ−1)/2 pairs of images. However, the resulting Mⱼ (Mⱼ−1)/2 equations would still correspond to only 2 Mⱼ−3 independent constraints, since each measurement is used multiple times, rendering the equations statistically correlated. Experimental data shows that employing linearization of the epipolar constraints results in a significantly more complex implementation, and yields inferior results compared to the approach described above.

### E. EKF Updates

The preceding section presents a measurement model that expresses the geometric constraints imposed by observing a static feature from multiple camera poses. Next, consider the update phase of the EKF, in which the constraints from observing multiple features are used. EKF updates are triggered by one of the following two events:

When a feature that has been tracked in a number of images is no longer detected, then all the measurements of this feature are processed using the method presented above in the section concerning Measurement Model. This case occurs most often, as features move outside the camera's field of view.

Every time a new image is recorded, a copy of the current camera pose estimate is included in the state vector (see the section concerning State Augmentation). If the maximum allowable number of camera poses, Nₘₐₓ, has been reached, at least one of the old ones must be removed. Prior to discarding states, all the feature observations that occurred at the corresponding time instants are used, in order to utilize their localization information. In one example, choose Nₘₐₓ/3 poses that are evenly spaced in time, starting from the second-oldest pose. These are discarded after carrying out an EKF update using the constraints of features that are common to these poses. One example always retains the oldest pose in the state vector, because the geometric constraints that involve poses further back in time typically correspond to larger baseline, and hence carry more valuable positioning information.

Consider next the update process. At a given time step the constraints of L features, selected by the above two criteria, must be processed. Following the procedure described in the preceding section, compute a residual vector rₒ^{(j)}, j=1 . . . L, as well as a corresponding measurement matrix Hₒ^{(j)}, j=1 . . . L for each of these features (cf. Equation 23). Stacking all residuals in a single vector yields:

$${r}_{o} = {H}_{x} \tilde{X} + {n}_{o} \qquad ( Equation 25 )$$

where rₒ and nₒ are vectors with block elements rₒ^{(j) and n}ₒ^{(j)}, j=1 . . . L respectively, and Hx is a matrix with block rows Hₓ^{(j)}, j=1 . . . L.

Since the feature measurements are statistically independent, the noise vectors nₒ^{(j)} are uncorrelated. Therefore, the covariance matrix of the noise vector nₒ is equal to Rₒ=σᵢₘ²I_{d}, where d=Σⱼ₌₁^{L}(2Mⱼ−3) is the dimension of the residual rₒ. In practice, d can be a quite large number. For example, if 10 features are seen in 10 camera poses each, the dimension of the residual is 170. In order to reduce the computational complexity of the EKF update, employ the QR decomposition of the matrix Hx. Specifically, denote this decomposition as

$${H}_{x} = [ \begin{matrix}{Q}_{1} & {Q}_{2}\end{matrix} ] [ \begin{matrix}{T}_{H} \\ 0\end{matrix} ]$$

where Q₁ and Q₂ are unitary matrices whose columns form bases for the range and nullspace of H_{X}, respectively, and T_{H} is an upper triangular matrix. With this definition, Equation 25 yields:

$${r}_{o} = [ \begin{matrix}{Q}_{1} & {Q}_{2}\end{matrix} ] [ \begin{matrix}{T}_{H} \\ 0\end{matrix} ] \tilde{X} + {n}_{o} ⇒ \qquad ( Equation 26 )$$

$$[ \begin{matrix}{Q}_{1}^{T} {r}_{o} \\ {Q}_{2}^{T} {r}_{o}\end{matrix} ] = [ \begin{matrix}{T}_{H} \\ 0\end{matrix} ] \tilde{X} + [ \begin{matrix}{Q}_{1}^{T} {n}_{o} \\ {Q}_{2}^{T} {n}_{o}\end{matrix} ] \qquad ( Equation 27 )$$

From the last equation it becomes clear that by projecting the residual rₒ on the basis vectors of the range of H_{X}, all the useful information in the measurements is retained. The residual Q₂^{T}rₒ is only noise, and can be completely discarded. For this reason, instead of the residual shown in Equation 25, employ the following residual for the EKF update:

$${r}_{n} = {Q}_{1}^{T} {r}_{o} = {T}_{H} \tilde{X} + {n}_{n} \qquad ( Equation 28 )$$

In this expression nₙ=Q₁^{T}nₒ is a noise vector whose covariance matrix is equal to Rₙ=Q₁^{T}RₒQ₁=σᵢₘ²Iᵣ, with r being the number of columns in Q₁. The EKF update proceeds by computing the Kalman gain:

$$K = {{PT}_{H}^{T} ( {T}_{H} {PT}_{H}^{T} + {R}_{n} )}^{- 1} \qquad ( Equation 29 )$$

while the correction to the state is given by the vector

$$Δ X = {Kr}_{n} \qquad ( Equation 30 )$$

In addition, the state covariance matrix is updated according to:

$${P}_{k + 1 \vert k + 1} = ( {I}_{ξ} - {KT}_{H} ) {{P}_{k + 1 \vert k} ( {I}_{ξ} - {KT}_{H} )}^{T} + {KR}_{n} {K}^{T} \qquad ( Equation 31 )$$

where ξ=6N+15 is the dimension of the covariance matrix.

Consider the computational complexity of the operations needed during the EKF update. The residual rₙ, as well as the matrix T_{H}, can be computed using Givens rotations in O(r²d) operations, without the need to explicitly form Q₁. On the other hand, Equation 31 involves multiplication of square matrices of dimension ξ, an O(ξ³) operation. Therefore, the cost of the EKF update is max(O(r²d), O(ξ³)). If, on the other hand, the residual vector rₒ was employed, without projecting it on the range of Hₓ, the computational cost of computing the Kalman gain would have been O(d³). Since typically d>>ξ,r, the use of the residual rₙ results in substantial savings in computation.

### Discussion

Consider next some of the properties of the described algorithm. As shown elsewhere in this document, the filter's computational complexity is linear in the number of observed features, and at most cubic in the number of states that are included in the state vector. Thus, the number of poses that are included in the state is the most significant factor in determining the computational cost of the algorithm. Since this number is a selectable parameter, it can be tuned according to the available computing resources, and the accuracy requirements of a given application. In one example, the length of the filter state is adaptively controlled during filter operation, to adjust to the varying availability of resources.

One source of difficulty in recursive state estimation with camera observations is the nonlinear nature of the measurement model. Vision-based motion estimation is very sensitive to noise, and, especially when the observed features are at large distances, false local minima can cause convergence to inconsistent solutions. The problems introduced by nonlinearity can be addressed using techniques such as Sigma-point Kalman filtering, particle filtering, and the inverse depth representation for features. The algorithm is robust to linearization inaccuracies for various reasons, including (i) the inverse feature depth parametrization used in the measurement model and (ii) the delayed linearization of measurements. According to the present subject matter, multiple observations of each feature are collected prior to using them for EKF updates, resulting in more accurate evaluation of the measurement Jacobians.

In typical image sequences, most features can only be reliably tracked over a small number of frames (“ opportunistic” features), and only a few can be tracked for long periods of time, or when revisiting places (persistent features). This is due to the limited field of view of cameras, as well as occlusions, image noise, and viewpoint changes, that result in failures of the feature tracking algorithms. If all the poses in which a feature has been seen are included in the state vector, then the proposed measurement model is optimal, except for linearization inaccuracies. Therefore, for realistic image sequences, the present algorithm is able to use the localization information of the opportunistic features. Also note that the state vector Xx is not required to contain only the IMU and camera poses. In one example, the persistent features can be included in the filter state, and used for SLAM. This can improve the attainable localization accuracy within areas with lengthy loops.

### Experimental Example

The algorithm described herein has been tested both in simulation and with real data. Simulation experiments have verified that the algorithm produces pose and velocity estimates that are consistent, and can operate reliably over long trajectories, with varying motion profiles and density of visual features.

The following includes the results of the algorithm in an outdoor experiment.

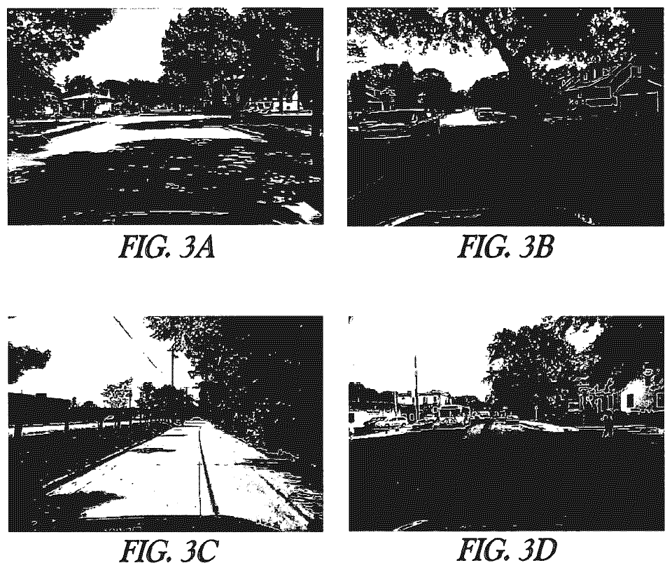

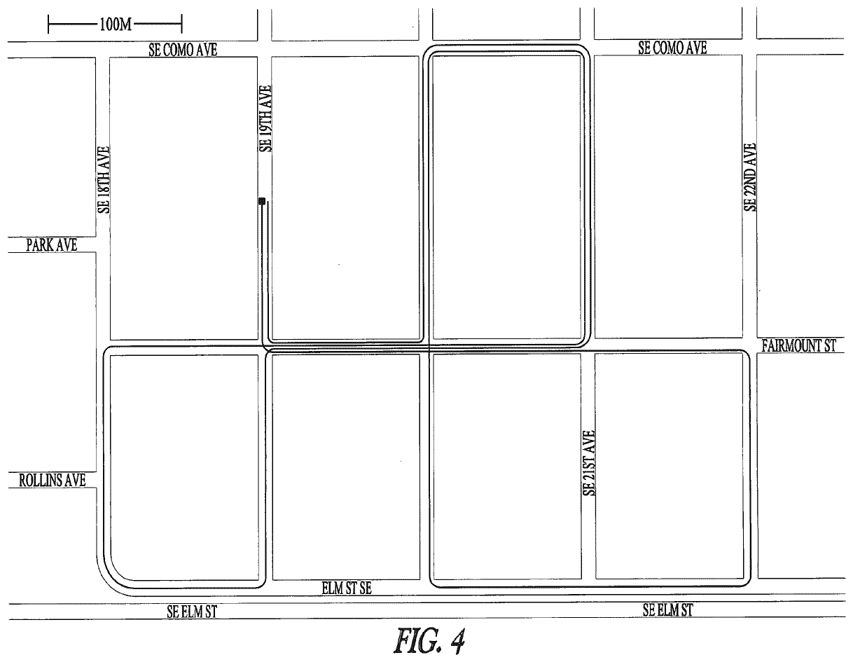

The experimental setup included a camera/IMU system, placed on a car that was moving on the streets of a typical residential area in Minneapolis, MN. The system included a Pointgrey FireFly camera, registering images of resolution 640×480 pixels at 3 Hz, and an Inertial Science ISIS IMU, providing inertial measurements at a rate of 100 Hz. During the experiment all data were stored on a computer and processing was done off-line. Some example images from the recorded sequence are shown in FIGS. 3A-3D.

The recorded sequence included a video of 1598 images representing about 9 minutes of driving.

For the results shown here, feature extraction and matching was performed using the SIFT algorithm. During this run, a maximum of 30 camera poses was maintained in the filter state vector. Since features were rarely tracked for more than 30 images, this number was sufficient for utilizing most of the available constraints between states, while attaining real-time performance. Even though images were only recorded at 3 Hz due to limited hard disk space on the test system, the estimation algorithm is able to process the dataset at 14 Hz, on a single core of an Intel T7200 processor (2 GHz clock rate). During the experiment, a total of 142903 features were successfully tracked and used for EKF updates, along a 3.2 km-long trajectory. The quality of the position estimates can be evaluated using a map of the area.

In FIG. 4, the estimated trajectory is plotted on a map of the neighborhood where the experiment took place. The initial position of the car is denoted by a red square on SE 19^{th} Avenue, and the scale of the map is shown on the top left corner.

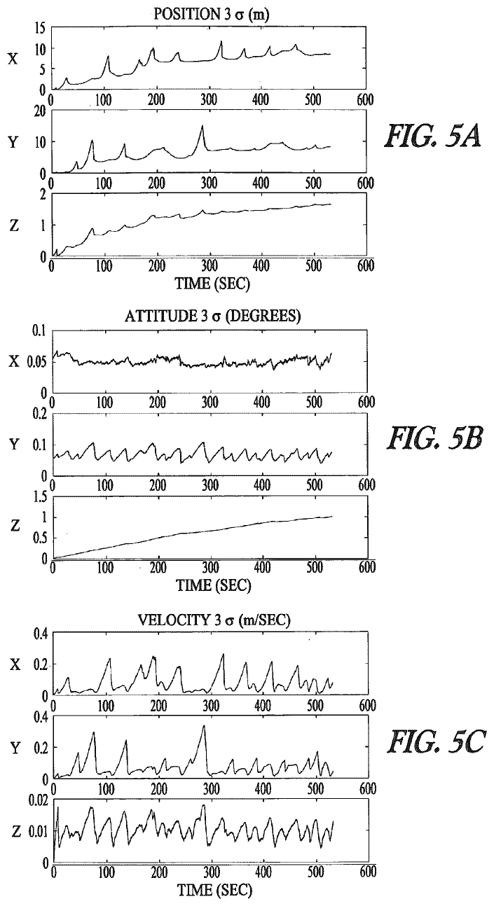

FIGS. 5A-5C are graphs illustrating the 36 bounds for the errors in the position, attitude, and velocity, respectively. The plotted values are 3-times the square roots of the corresponding diagonal elements of the state covariance matrix. Note that the EKF state is expressed in ECEF frame, but for plotting, all quantities have been transformed in the initial IMU frame, whose x axis is pointing approximately south, and its y axis east.

The trajectory follows the street layout quite accurately and, additionally, the position errors that can be inferred from this plot agree with the 36 bounds shown in FIG. 5A. The final position estimate, expressed with respect to the starting pose, is \hat{X}_{final}=[−7.92 13.14 −0.78]^{T} m. From the initial and final parking spot of the vehicle it is known that the true final position expressed with respect to the initial pose is approximately X_{final}=[0 7 0]^{T} m. Thus, the final position error is approximately 10 m in a trajectory of 3.2 km, i.e., an error of 0.31% of the traveled distance. This is remarkable, given that the algorithm does not utilize loop closing, and uses no prior information (for example, nonholonomic constraints or a street map) about the car motion. Note also that the camera motion is almost parallel to the optical axis, a condition which is particularly adverse for image-based motion estimation algorithms. In FIG. 5B and FIG. 5C, the 36 bounds for the errors in the IMU attitude and velocity along the three axes are shown. From these, observe that the algorithm obtains accuracy (3σ) better than 1° for attitude, and better than 0.35 m/sec for velocity in this particular experiment.

The results demonstrate that the algorithm is capable of operating in a real-world environment, and producing very accurate pose estimates in real-time. Note that in the dataset presented here, several moving objects appear, such as cars, pedestrians, and trees whose leaves move in the wind. The algorithm is able to discard the outliers which arise from visual features detected on these objects, using a simple Mahalanobis distance test. Robust outlier rejection is facilitated by the fact that multiple observations of each feature are available, and thus visual features that do not correspond to static objects become easier to detect. Note also that the method can be used either as a stand-alone pose estimation algorithm, or combined with additional sensing modalities to provide increased accuracy. For example, a GPS sensor (or other type of sensor) can be used to compensate for position drift.

The present subject matter includes an EKF-based estimation algorithm for real-time vision-aided inertial navigation. One aspect of this work is the derivation of a measurement model that is able to express the geometric constraints that arise when a static feature is observed from multiple camera poses. This measurement model does not require including the 3D feature positions in the state vector of the EKF, and is optimal, up to the errors introduced by linearization. The resulting EKF-based pose estimation algorithm has computational complexity linear in the number of features, and is capable of very accurate pose estimation in large-scale real environments. One example includes fusing inertial measurements with visual measurements from a monocular camera. However, the approach is general and can be adapted to different sensing modalities both for the proprioceptive, as well as for the exteroceptive measurements (e.g., for fusing wheel odometry and laser scanner data).

### Selected Calculations

Intersection can be used to compute an estimate of the position of a tracked feature ƒⱼ. To avoid local minima, and for better numerical stability, during this process, use an inverse-depth parametrization of the feature position. In particular, if {Cn} is the camera frame in which the feature was observed for the first time, then the feature coordinates with respect to the camera at the i-th time instant are:

$${C}_{{i}_{{p}_{{f}_{j}}}} = C ( {}_{{C}_{n}}^{{C}_{i}} \overline{q} ) {C}_{{n}_{{p}_{{f}_{j}}}} + {C}_{{i}_{{p}_{{f}_{j}}}} , i ∈ {S}_{j} \qquad ( Equation 32 )$$

In this expression

$$C ( {}_{{C}_{n}}^{{C}_{i}} \overline{q} ) and {C}_{{i}_{{p}_{{C}_{n}}}}$$

are the rotation and translation between the camera frames at time instants n and i, respectively. Equation 32 can be rewritten as:

$${C}_{{i}_{{p}_{{f}_{j}}}} = {C}_{{n}_{{Z}_{j}}} ( C ( {}_{{C}_{n}}^{{C}_{i}} \overline{q} ) [ \begin{matrix}\frac{{C}_{{n}_{{X}_{j}}}}{{C}_{{n}_{{Z}_{j}}}} \\ \frac{{C}_{{n}_{{Y}_{j}}}}{{C}_{{n}_{{Z}_{j}}}} \\ 1\end{matrix} ] + \frac{1}{{C}_{{n}_{{Z}_{j}}}} {C}_{{i}_{{p}_{{C}_{n}}}} ) \qquad ( Equation 33 )$$

$$= {C}_{{n}_{{Z}_{j}}} ( C ( {}_{{C}_{n}}^{{C}_{i}} \overline{q} ) [ \begin{matrix}{α}_{j} \\ {β}_{j} \\ 1\end{matrix} ] + {ρ}_{j} {C}_{{i}_{{p}_{{C}_{n}}}} ) \qquad ( Equation 34 )$$

$$= {C}_{{n}_{{Z}_{j}}} [ \begin{matrix}{h}_{i 1} ( {α}_{j} , {β}_{j} , {ρ}_{j} ) \\ {h}_{i 2} ( {α}_{j ,} {β}_{j} , {ρ}_{j} ) \\ {h}_{i 3} ( {α}_{j} , {β}_{j} , {ρ}_{j} )\end{matrix} ] \qquad ( Equation 35 )$$

In the last expression hᵢ₁, hᵢ₂ and hᵢ₃ are scalar functions of the quantities αⱼ, βⱼ, ρⱼ, which are defined as:

$${α}_{j} = \frac{{C}_{{n}_{{X}_{j}}}}{{C}_{{n}_{{Z}_{j}}}} , {β}_{j} = \frac{{C}_{{n}_{{Y}_{j}}}}{{C}_{{n}_{{Z}_{j}}}} , {ρ}_{j} = \frac{1}{{C}_{{n}_{{Z}_{j}}}} , \qquad ( Equation 36 )$$

Substituting from Equation 35 into Equation 18, express the measurement equations as functions of αⱼ, βⱼ, and ρⱼ only:

$${z}_{i}^{( j )} = \frac{1}{{h}_{i 3} ( {α}_{j} , {β}_{j} , {ρ}_{j} )} [ \begin{matrix}{h}_{i 1} ( {α}_{j} , {β}_{j} , {ρ}_{j} ) \\ {h}_{i 2} ( {α}_{j} , {β}_{j} , {ρ}_{j} )\end{matrix} ] + {n}_{i}^{( j )} \qquad ( Equation 37 )$$

Given the measurements zᵢ^{(j)}, i∈Sⱼ, and the estimates for the camera poses in the state vector, obtain estimates for \hat{α}ⱼ, \hat{β}ⱼ, and \hat{ρ}ⱼ, using Gauss-Newton least squares minimization. Then, the global feature position is computed by:

$${G}_{{\hat{p}}_{{f}_{j}}} = \frac{1}{{\hat{ρ}}_{j}} {C}^{T} ( {}_{{C}_{n}}^{{C}_{i}} \hat{\overline{q}} ) [ \begin{matrix}{\hat{α}}_{j} \\ {\hat{β}}_{j} \\ 1\end{matrix} ] + {G}_{{\hat{p}}_{{C}_{n}}} \qquad ( Equation 38 )$$

Note that during the least-squares minimization process the camera pose estimates are treated as known constants, and their covariance matrix is ignored. As a result, the minimization can be carried out very efficiently, at the expense of the optimality of the feature position estimates. Recall, however, that up to a first-order approximation, the errors in these estimates do not affect the measurement residual (cf. Equation 23). Thus, no significant degradation of performance is inflicted.

### Additional Notes

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown and described. However, the present inventors also contemplate examples in which only those elements shown and described are provided.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, the code may be tangibly stored on one or more volatile or non-volatile computer-readable media during execution or at other times. These computer-readable media may include, but are not limited to, hard disks, removable magnetic disks, removable optical disks (for example, compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

1. (canceled)

2. A vision-aided inertial navigation system (VINS) comprising:
a camera configured to provide a plurality of images captured at a plurality of poses along a trajectory, wherein the plurality of images comprise one or more features observed at the plurality of poses along the trajectory at a first plurality of time points;
an inertial measurement unit (IMU) configured to provide a set of IMU measurements taken along the trajectory at a second plurality of time points, wherein the second plurality of time points are distinct from the first plurality of time points; and
a processor communicatively coupled to the camera and the IMU, the processor configured to:
determine, from the plurality of images, a set of one or more feature measurements corresponding to position estimates for the one or more features;
update a state vector, to produce an updated state vector, based on the set of one or more feature measurements, wherein:
the state vector comprises a set of state estimates for position and orientation for each of the plurality of poses along the trajectory;
the state vector is updated based on:
a non-linear filter, wherein the non-linear filter is configured to separate an oldest subset of the set of state estimates for position and orientation from the state vector at each of the first plurality of time points;
the set of IMU measurements; and
the set of one or more feature measurements; and
the position estimates for the one or more features are maintained separately from the state vector;
output navigation data corresponding to the updated state vector; and
perform a navigation function based on the navigation data.

3. The VINS of claim 2, wherein:
the VINS is incorporated into an unmanned aerial vehicle; and
the set of IMU measurements comprise measurements of angular velocity and measurements of linear acceleration.

4. The VINS of claim 2, wherein:
the VINS further comprises a display screen; and
outputting the navigation data comprises projecting the navigation data on the display screen.

5. The VINS of claim 4, wherein:
the navigation data is overlaid on a map of an area surrounding the VINS; and
the map is projected on the display screen.

6. The VINS of claim 2, wherein updating the state vector comprises implementing the non-linear filter to compute one or more constraints based on the set of one or more feature measurements.

7. The VINS of claim 6, wherein:
the updated state vector comprises a set of updated state estimates for position and orientation; and
the set of updated state estimates for position and orientation is computed relative to:
at least one of the one or more constraints; and
the set of IMU measurements.

8. The VINS of claim 6, wherein computing the one or more constraints comprises modifying a residual of the set of one or more feature measurements to reduce feature estimate error.

9. The VINS of claim 2, wherein the non-linear filter is an Extended Kalman Filter (EKF).

10. A method, comprising:
receiving, with a processor:
a plurality of images from a camera communicatively coupled to the processor, wherein the plurality of images comprise one or more features observed at a plurality of poses along a trajectory at a first plurality of time points; and
a set of inertial measurement unit (IMU) measurements from an IMU communicatively coupled to the processor, wherein:
the set of IMU measurements are taken along the trajectory at a second plurality of time points; and
the second plurality of time points are distinct from the first plurality of time points;
determining, from the plurality of images and using the processor, a set of one or more feature measurements corresponding to position estimates for the one or more features;
updating a state vector with the processor, to produce an updated state vector, based on the set of one or more feature measurements, wherein:
the state vector comprises a set of state estimates for position and orientation for each of the plurality of poses along the trajectory;
the state vector is updated based on:
a sliding window filter;
the set of IMU measurements; and
the set of one or more feature measurements; and
the position estimates for the one or more features are maintained separately from the state vector;
outputting, using the processor, navigation data corresponding to the updated state vector; and
performing, with the processor, a navigation function with the processor based on the navigation data.

11. The method of claim 10, wherein:
the processor is incorporated into an unmanned aerial vehicle; and
the set of IMU measurements comprise measurements of angular velocity and measurements of linear acceleration.

12. The method of claim 10, wherein outputting the navigation data comprises projecting the navigation data on a display screen.

13. The method of claim 10, wherein updating the state vector comprises implementing the sliding window filter to compute one or more constraints based on the set of one or more feature measurements.

14. The method of claim 13, wherein:
the updated state vector comprises a set of updated state estimates for position and orientation; and
the set of updated state estimates for position and orientation is computed relative to:
at least one of the one or more constraints; and
the set of IMU measurements.

15. The method of claim 13, wherein computing the one or more constraints comprises modifying a residual of the set of one or more feature measurements to reduce feature estimate error.

16. A non-transitory computer-readable storage medium comprising instructions that configure a processor to:
receive:
a plurality of images from a camera, wherein the plurality of images comprise one or more features observed at a plurality of poses along a trajectory at a first plurality of time points; and
a set of inertial measurement unit (IMU) measurements from an IMU, wherein:
the set of IMU measurements are taken along the trajectory at a second plurality of time points; and
the second plurality of time points are distinct from the first plurality of time points;
determine, from the plurality of images, a set of one or more feature measurements corresponding to position estimates for the one or more features;
update a state vector, to produce an updated state vector, based on the set of one or more feature measurements, wherein:
the state vector comprises a set of state estimates for position and orientation for each of the plurality of poses along the trajectory;
the state vector is updated based on:
a sliding window filter;
the set of IMU measurements; and
the set of one or more feature measurements; and
the position estimates for the one or more features are maintained separately from the state vector;
output navigation data corresponding to the updated state vector; and
perform a navigation function based on the navigation data.

17. The non-transitory computer-readable storage medium of claim 16, wherein:
the processor is incorporated into an unmanned aerial vehicle; and
the set of IMU measurements comprise measurements of angular velocity and measurements of linear acceleration.

18. The non-transitory computer-readable storage medium of claim 16, wherein outputting the navigation data comprises projecting the navigation data on a display screen.

19. The non-transitory computer-readable storage medium of claim 16, wherein updating the state vector comprises implementing the sliding window filter to compute one or more constraints based on the set of one or more feature measurements.

20. The non-transitory computer-readable storage medium of claim 19, wherein:
the updated state vector comprises a set of updated state estimates for position and orientation; and
the set of updated state estimates for position and orientation is computed relative to:
at least one of the one or more constraints; and
the set of IMU measurements.

21. The non-transitory computer-readable storage medium of claim 19, wherein computing the one or more constraints comprises modifying a residual of the set of one or more feature measurements to reduce feature estimate error.
